(19) United States
(12) Patent Application Publication
(10) Pub. No.: US 2026/0208591 A1
(43) Pub. Date: Jul. 23, 2026

(54) DISTRIBUTION DEVICE FOR A HIGH-VOLTAGE SYSTEM OF AN ELECTRIC VEHICLE

(71) Applicant: SCHAEFFLER TECHNOLOGIES AG & CO. KG, Herzogenaurach (DE)

(72) Inventors: Stephanie PREISLER, Hemau (DE); Richard WELDLE, Regensburg (DE)

(73) Assignee: SCHAEFFLER TECHNOLOGIES AG & CO. KG, Herzogenaurach (DE)

(21) Appl. No.: 19/141,730

(22) PCT Filed: Dec. 12, 2023
(86) PCT No.: PCT/EP2023/085315

§ 371 Date: Jun. 20, 2025

(30) Foreign Application Priority Data
Dec. 21, 2022 (DE) 102022214171.7
Apr. 19, 2023 (DE) 102023203599.5

(51) Int. Cl. B60L 3/00; B60L 3/04; H02J 1/08; H02J 7/50

(52) U.S. Cl. CPC B60L 3/0023; B60L 3/04; H02J 1/08; H02J 7/50; B60L 2210/10; H02J 2207/20

(57) ABSTRACT

A distribution device for a high-voltage system of an electric vehicle has a first sup-ply line having a first line section, a second line section and a controllable second switchgear unit. The distribution device further has a second supply line having a third line section, a fourth line section and a controllable fifth switchgear unit. Furthermore, the distribution device has a third supply line having a controllable third switchgear unit, wherein the third switchgear unit connects the second line section of the first supply line and third line section of the second supply line. The various line sections are designed for connecting to various high-voltage components.

### CROSS-REFERENCE TO RELATED APPLICATIONS

This application is the U.S. National Phase Application of PCT International Application No. PCT/EP2023/085315, filed Dec. 12, 2023, which claims priority to German Patent Application No. 102023203599.5, filed Apr. 19, 2023, and German Patent Application No. 102022214171.7, filed Dec. 21, 2022, the contents of such applications being incorporated by reference herein.

### DESCRIPTION

### Field of the Invention

The invention relates to a distribution device for a high-voltage system of an electric vehicle. The invention also relates to a method and a control unit for operating the high-voltage system, and a computer program and a computer-readable medium.

### Background of the Invention

High-voltage systems that are used in battery electric vehicles (BEVs) are generally of simple construction, i.e. all high-voltage components only have a simple presence or are only present once in the system. Vehicles in higher classes additionally have two or more high-voltage drive units, mostly to increase the system drive power and to realize all-wheel drive. The voltage level of the high-voltage system is usually in the range around 400 V, wherein newer systems are increasingly also constructed at a level of 800 V, which enables increased charging powers and with which system efficiency can additionally be improved. In order to enable “legacy charging” (charging an 800 V system at a 400 V DC charging column) on these systems, switchable 400V/800V battery systems are meanwhile also being discussed, these consist of two 400 V battery stacks which can be changed over from series interconnection (corresponds to 800 V) to parallel operation (corresponds to 400 V) for charging.

Highly autonomously driving vehicles are technically divided into five classes or levels L1 to L5, wherein the highest degree of safety and redundancy must be ensured for the highest autonomy levels L4 and L5 in particular. According to the current state of discussions in the industry, a separation of the high-voltage battery into two independent cell stacks is also necessary here in order to ensure that the vehicle, particularly the voltage converters (DCDCs), is supplied with sufficient operating voltage even in the event of a fault. It is worth focussing particular attention in this case on the high-voltage/low-voltage (HV/LV) DCDCs, which are redundant, i.e. implemented at least twice, in a highly autonomous vehicle, as these high-voltage/low-voltage DCDCs must guarantee satisfactory supply of the LV on-board electrical system. As the supply system of the braking and control systems and the associated open- and closed-loop control units inter alia, the latter is generally given the highest safety target (ASIL D).

Traction redundancy requires at least one energy source per drive, that is to say a high-voltage battery in a battery electric vehicle, and a drive unit that is supplied using same. In order to be able to cover corresponding fault cases and component and system failures also, this means that two batteries or independent battery cell stacks inside one battery, and two drive units are required for realizing redundancy.

BEVs that are available or discussed today, which have 800 V battery systems that are switchable for legacy charging and which additionally—generally for increasing power and efficiency—have two electric motors are not able, in spite of existing component redundancy, to reproduce the required traction redundancy. This can be traced back to the fact that the drives that are mostly realized as 800 V components cannot be changed over from the 800 V whole battery to one of the individual 400 V battery stacks in the event of a fault. Thus, propulsion of the vehicle can no longer be guaranteed in the event of a fault.

Therefore, on-board-electrical-system and traction redundancy is currently implemented by means of expensive component redundancy, also termed symmetrical redundancy, without particular functional added value.

### SUMMARY OF THE INVENTION

An aspect of the invention aims to cost-effectively providing a distribution device for a high-voltage system of an electric vehicle, which makes it possible to fulfill the safety and redundancy requirements of the highest autonomy levels L4 and L5.

According to a first aspect of the invention, disclosed is a distribution device for a high-voltage system of an electric vehicle, wherein the high-voltage system comprises a first high-voltage electrical system and a second high-voltage electrical system. The distribution device has a first supply line having a first line section, a second line section and a controllable second switchgear unit. The second switchgear unit connects the first line section and second line section in a closed state and decouples the first line section and second line section in an open state.

The distribution device further has a second supply line having a third line section, a fourth line section and a controllable fifth switchgear unit. The fifth switchgear unit connects the third line section and fourth line section in a closed state and decouples the third line section and fourth line section in an open state.

Furthermore, the distribution device has a third supply line having a controllable third switchgear unit, wherein the third switchgear unit connects the second line section of the first supply line and third line section of the second supply line.

The first line section of the first supply line is designed for connecting to a first terminal of a first energy source, to a first terminal of a first electrical machine, to a first terminal of a charging unit, to a first terminal of a first DC/DC converter and to a first terminal of at least one further high-voltage load.

The second line section of the first supply line is designed for connecting to a first terminal of a second energy source and to a first terminal of a second DC/DC converter.

The third line section of the second supply line is designed for connecting to a second terminal of the first energy source and to a second terminal of the first DC/DC converter.

The fourth line section of the second supply line is designed for connecting to a second terminal of the second energy source, to a second terminal of the second electrical machine, to a second terminal of a second DC/DC converter and to a second terminal of a charging unit.

The first high-voltage electrical system preferably has at least the first energy source. In particular, the first high-voltage electrical system additionally has the first DC/DC converter and/or the first electrical machine and/or the at least one further high-voltage load. The second high-voltage electrical system preferably has at least the second energy source. In particular, the second high-voltage electrical system additionally has the second DC/DC converter and/or the second electrical machine and/or the charging unit.

The first energy source and/or the second energy source preferably comprise a battery or a battery stack in each case. Alternatively or additionally, the first energy source and the second energy source can comprise fuel cells.

The distribution device enables traction redundancy. Traction redundancy requires at least one energy source per drive, that is to say a high-voltage battery in a battery electric vehicle, and a drive unit that is supplied using same. In order to be able to cover corresponding fault cases and component and system failures also, the distribution device is designed to provide two batteries and two drive units in a suitable manner.

The distribution device enables disconnection of the electrical systems under load. The drives are de-energized when the energy sources are changed over.

The principle of energy source change-over can be applied to different on-board electrical system topologies (parallel, series, etc.) and can be extended by both the separation of the high-voltage electrical systems (series topology) and the disconnection of one high-voltage electrical system (parallel topology) in the event of a fault.

The solution therefore unifies the advantages of different supply system topologies in one system and, in addition to the frequently requested possibility of legacy charging, enables the highest degree of drivetrain efficiency with independent redundant supply of safety-critical components at the same time.

In at least one advantageous embodiment according to the first aspect, the second line section of the first supply line is designed for connecting to a first terminal of the second electrical machine. The third line section of the second supply line is designed for connecting to a second terminal of the first electrical machine and to a second terminal of the at least one further high-voltage load.

In at least one advantageous embodiment according to the first aspect, the first supply line has a switchable first switchgear unit which is arranged in the first line section and divides the first line section into a fifth and sixth line section. Here, the fifth line section of the first supply line is designed for connecting to the first terminal of the first energy source, to the first terminal of the first electrical machine, to a first terminal of the first DC/DC converter and to the first terminal of the at least one further high-voltage load. The sixth line section of the first supply line is here designed for connecting to the first terminal of the charging unit and the first terminal of the second electrical machine. The fourth line section of the second supply line is designed for connecting to a second terminal of the at least one high-voltage load and to a second terminal of the first electrical machine.

In at least one advantageous embodiment according to the first aspect, the third switchgear unit is designed to control opening of the third switchgear unit automatically and/or the second switchgear unit is designed to control opening of the second switchgear unit automatically.

In at least one advantageous embodiment according to the first aspect, the third switchgear unit has a controllable disconnector and a monitoring unit, wherein the monitoring unit is arranged in the third switchgear unit and is designed to detect a current which is flowing in the third switchgear unit and/or a voltage which is applied at the third switchgear unit, and to transition the controllable disconnector to an open state if a magnitude of the current or the voltage exceeds a specified first value or falls below a specified second value. Alternatively or additionally, the second switchgear unit has a controllable disconnector and a monitoring unit, wherein the monitoring unit is arranged in the second switchgear unit and is designed to detect a current which is flowing in the second switchgear unit and/or a voltage which is applied at the second switchgear unit, and to transition the controllable disconnector to an open state if a magnitude of the current or the voltage exceeds a specified first value or falls below a second specified value.

In at least one advantageous embodiment according to the first aspect, the controllable disconnector of the third switchgear unit or the second switchgear unit can additionally be activated by means of the control unit.

A plurality of change-over or disconnect devices, i.e. a plurality of switchgear units, are used in the distribution device for the applications both in the series and in the parallel topology. The requirements on these are very different compared to legacy charging due to the flowing currents that are to be taken into account (switching under load) and required switch-off times. A strong drop off of the voltage is avoided in the non-defective electrical subsystem that is to be disconnected.

The first switchgear unit and the fifth switchgear unit preferably likewise have controllable disconnectors. These can have the same or a different design as the controllable disconnectors of the third and second switchgear units. The controllable disconnectors of the first switchgear unit and the fifth switchgear unit are controlled only by the control unit in particular however.

The controllable disconnectors are designed as semiconductor disconnectors for example. The controllable disconnectors in particular have one or more semiconductor transistors. The controllable disconnectors have for example at least two power metal oxide semiconductor field effect transistors which are connected anti-series (back-to-back arrangement). Alternatively or additionally, at least the second switchgear unit and the third switchgear unit can have a pyrofuse or a relay or a contactor.

According to a second and third aspect of the invention, disclosed is a method and a corresponding control unit for operating a high-voltage system of an electric vehicle, wherein the high-voltage system has a first high-voltage electrical system and a second high-voltage electrical system and also a distribution device according to the first aspect. The first high-voltage electrical system preferably has at least the first energy source. In particular, the first high-voltage electrical system additionally has the first DC/DC converter and/or the first electrical machine and/or the at least one further high-voltage load. The second high-voltage electrical system preferably has at least the second energy source. In particular, the second high-voltage electrical system additionally has the second DC/DC converter and/or the second electrical machine and/or the charging unit.

Here, the control unit receives monitoring data or monitoring signals from the monitoring unit of the third switchgear unit, wherein the monitoring data or the monitoring signals are formed to signal to the control unit that opening of the third switchgear unit has been triggered and a short circuit has been detected. In response to the receipt of the monitoring signal, the control unit generates and sends a first control signal to the first switchgear unit, wherein the first control signal is formed to cause the disconnector of the first switchgear unit to assume an open state.

In a further step, the control unit sends diagnostic data to a central computing unit to ascertain what type of fault exists. The diagnostic data here at least specify that the third switchgear unit has been transitioned to an open state or a short circuit has been detected. In response to the sending of the diagnostic data to the central computing unit, the control unit receives a control command from the central computing unit.

If the central computing unit ascertains that a short circuit exists in the first high-voltage electrical system and the second high-voltage electrical system, the control command includes no instruction that causes the control unit to reconnect one of the high-voltage electrical systems.

If, however, the central computing unit ascertains that a short circuit only exists in the first high-voltage electrical system, the control command includes an instruction to send a second control signal to the second switchgear unit, wherein the second control signal is formed to cause the disconnector of the second switchgear unit to be transitioned to a closed state.

If the central computing unit ascertains that a short circuit only exists in the second high-voltage electrical system, the control command includes an instruction to send a third control signal to the fifth switchgear unit, wherein the third control signal is formed to cause the respective disconnector of the fifth switchgear unit to be transitioned to a closed state.

If the central computing unit ascertains that no short circuit exists, the control command includes an instruction to send a fourth control signal to the first switchgear unit and third switchgear unit, wherein the fourth control signal is formed to cause the respective disconnector of the first switchgear unit and the third switchgear unit to be transitioned to a closed state.

The control unit executes the control command. The control unit in particular comprises a computing unit having a processor and a program memory, wherein a program is stored in the program memory, and when the program is executed by the processor, the computing unit and thus the control unit executes the method according to the second aspect.

In at least one advantageous embodiment according to the second and third aspects, if only one short circuit exists in one of the high-voltage electrical systems, the control unit receives up-to-date measurement data from the monitoring unit of the third switchgear unit and forwards the measurement data to the central computing unit, wherein the measurement data are representative for one or more voltages which have been detected after the opening of the first switchgear unit. In response to the forwarding of the measurement data, the control unit receives a further control command from the central computing unit. The further control command includes an instruction to send a fifth control signal to the second switchgear unit or fifth switchgear unit, wherein the fifth control signal is formed to cause the disconnector of the second switchgear unit or the fifth switchgear unit to be transitioned to an open state. Furthermore, the further control command includes the instruction to send a sixth control signal to the first switchgear unit and third switchgear unit, wherein the sixth control signal is formed to cause the respective disconnector of the first switchgear unit and the third switchgear unit to be transitioned to a closed state.

Advantageous configurations of the first aspect also apply to the second and third aspects.

In the case of series topologies, there is the possibility of a central change-over of the high-voltage electrical machines from 800 V to 400 V. The two battery stacks, which are normally coupled in series, can be disconnected from one another in the event of a fault, wherein this results in two high-voltage electrical systems which are isolated from and independent of one another. The defective electrical system, for example due to load short circuit, battery stack failure, insulation fault, etc. can be deactivated completely and the vehicle can continue to be operated in a reduced-power mode (limp home) at an operating voltage of 400 V. For this, the electrical machines (in the event of malfunction of one of the electrical machines only the second electrical machine, which is still available) are connected to the intact 400 V electrical subsystem and the continuation of traction operation is thus ensured.

The focus of the change-over/disconnection function in this case is the redundant supply of safety-critical loads in the event of a fault, particularly the high-voltage drive and the low-voltage DCDC converter. The legacy charging of the 800 V whole battery at a 400 V DC charging column and 800 V DC charging column are possible. In normal operation, the efficient use of the 800 V voltage for traction is possible and in the event of a fault, driving using 400 V is possible.

In the event of a temporary switching off/disconnection, for example for the thermal protection of the energy source, it is possible to reconnect the disconnected high-voltage electrical system and to return the vehicle to normal operation after “healing” of the defective function/components.

Thus, using the distribution device, the battery-operated vehicle can ensure the autonomy levels L4 and L5 in relation to the subjects of traction redundancy and independent and redundant supply of the 12 V on-board electrical system. By further integration of fuses for high-voltage loads into the distribution device, autonomy levels L4 and L5 can be further protected.

According to a fourth aspect of the invention, disclosed is a high-voltage system for an electric vehicle, wherein the high-voltage system has a first high-voltage electrical system and a second high-voltage electrical system, a distribution device according to the first aspect or an advantageous configuration of same, and a control unit according to the third aspect.

Advantageous configurations of the third aspect also apply in this case to the fourth aspect.

According to a fifth aspect of the invention, disclosed is a computer program which has commands which, when the computer program is executed by a computing unit of a high-voltage system of an electric vehicle, cause the computing unit to execute the steps of the method according to the second aspect or an advantageous configuration of same.

According to a sixth aspect of the invention, disclosed is a computer-readable medium which has commands which, when executed by a computing unit of a high-voltage system of an electric vehicle, cause the computing unit to execute the method according to the second aspect or an advantageous configuration of same.

Within the meaning of this document, the designation of a computer program of this kind is equivalent to the concept of a program element and/or a computer program product which contains instructions for controlling the computing unit, in order to coordinate the manner of operation of the system or of the method in a suitable manner, in order to achieve the effects associated with the method according to an aspect of the invention.

The computing unit preferably has a processor and a memory. The processor can comprise a central processing unit (CPU) and the processor may furthermore be a further all-purpose processor, a microcontroller, a digital signal processor (DSP). The all-purpose processor can be a microprocessor, or the processor can be an arbitrary conventional processor or the like.

The computer program can be implemented as computer-readable instruction code in any suitable programming language, such as in JAVA, C++, etc. The computer program can be stored on a computer-readable storage medium (CD-ROM, DVD, Blu-ray disk, removable drive, volatile or non-volatile memory, integral memory/processor etc.). The instruction code can program a computer, a computing unit or other programmable devices, such as a control device for a drive of a motor vehicle in particular, in such a way that the desired functions are executed. Furthermore, the computer program may be provided in a network such as the Internet, from which a user can download it as required.

Further advantageous configurations are disclosed in the appended claims and the following description of exemplary embodiments with reference to the appended figures. The description of the subjects specified here is not limited to the individual special embodiments. Features of different exemplary embodiments can—as far as technically reasonable—be combined with each other in order to form further exemplary embodiments. For example, variations or modifications described with respect to one of the exemplary embodiments may also be applicable to other exemplary embodiments, unless indicated otherwise.

### BRIEF DESCRIPTION OF THE DRAWINGS

In the drawings:

FIG. 1 shows an exemplary block diagram for an exemplary embodiment of a first high-voltage system for an electrically driven vehicle,

FIG. 2 shows an exemplary block diagram for an exemplary embodiment of a second high-voltage system for an electrically driven vehicle,

FIG. 3 shows an exemplary flowchart for a program for operating the high-voltage electrical system according to FIG. 1

FIG. 4 shows an exemplary flowchart for a further program for operating the high-voltage electrical system according to FIG. 2.

In the figures, the same reference signs are used for elements with essentially the same function, but these elements do not have to be identical in all details.

### DETAILED DESCRIPTION OF EXEMPLARY EMBODIMENTS

It is pointed out that, if an element is referred to as being “connected” or “coupled” to another element, the element may be connected or coupled directly to the other element or intermediate elements may be present. In contrast, if an element is referred to as being “connected” or “coupled” “directly” to another element, there are no intermediate elements present. Other expressions used to describe the relationship between elements should be interpreted in the same way (e.g. “between” versus “directly between”, “adjacent” versus “directly adjacent”, etc.).

In exemplary embodiments which are described here or shown in the drawings, any direct electrical connection or coupling, i.e. any connection or coupling without additional elements located between them, can also be implemented by an indirect connection or coupling, i.e. a connection or coupling having one or more elements located between them, or vice versa as long as the general purpose of the connection or coupling, for example transmitting a particular type of signal or the transmission of a particular type of information, is essentially retained.

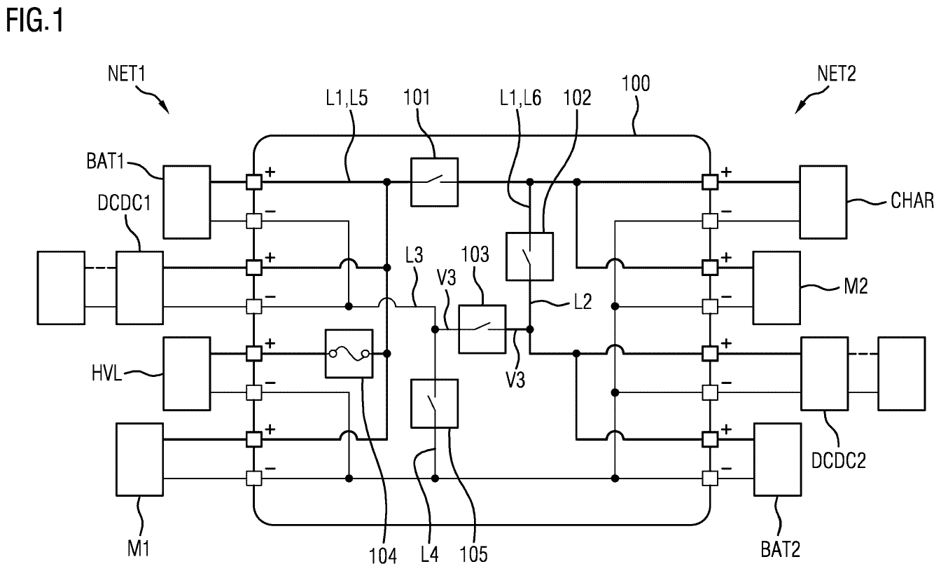

FIG. 1 shows an exemplary block diagram for an exemplary embodiment of a first high-voltage system for an electrically driven vehicle.

The high-voltage system comprises a first high-voltage electrical system NET1, a second high-voltage electrical system NET2 and a distribution system.

The first high-voltage electrical system NET1 comprises a first energy source BAT1, a first electrical machine M1, a first DC/DC converter DCDC1 and one or more high-voltage loads HVL.

The second high-voltage electrical system NET2 comprises a second energy source BAT2, a second electrical machine M2, a second DC/DC converter DCDC2 and a charging unit CHAR.

The first energy source BAT1 and the second energy source BAT2 are preferably high-voltage batteries.

The distribution system comprises a distribution device and a control unit (not shown in FIG. 1). Furthermore, a central computing unit (not shown in FIG. 1) is assigned to the distribution system, wherein the control unit is designed to provide data for transmission to the computing unit or to receive data from same. A data connection between the control unit and the computing unit can be effected in a wired or wireless manner.

The distribution device comprises a first supply line having a first line section L1, a second line section L2 and a controllable second switchgear unit 102, wherein the second switchgear unit 102 connects the first line section L1 and second line section L2 in a closed state and decouples the first line section L1 and second line section L2 in an open state. Furthermore, the first supply line has a first switchgear unit 101 which is arranged in the first line section L1 and divides the first line section into a fifth line section L5 and a sixth line section L6.

Furthermore, the distribution device has a second supply line having a third line section L3, a fourth line section L4 and a controllable fifth switchgear unit 105, wherein the fifth switchgear unit 105 connects the third line section L3 and fourth line section L4 in a closed state and decouples the third line section L3 and fourth line section L4 in an open state.

Furthermore, the distribution device has a third supply line V3 having a controllable third switchgear unit 103, wherein the third supply line V3 connects the second line section L2 of the first supply line and third line section L3 of the second supply line when the third switchgear unit 103 is in a closed state.

The fifth line section L5 of the first supply line is designed for connecting or is connected to a first terminal of the first energy source BAT1, to a first terminal of the first DC/DC converter DCDC1 and to a first terminal of the at least one high-voltage load HVL and also to a first terminal of the first electrical machine M1.

The sixth line section L6 of the first supply line is designed for connecting or is connected to a first terminal of the second electrical machine M2 and to a first terminal of the charging unit CHARG.

The second line section L2 of the first supply line is designed for connecting or is connected to a first terminal of the second energy source BAT2 and to a first terminal of the second DC/DC converter DCDC2.

The third line section L3 of the second supply line is designed for connecting or is connected to a second terminal of the first energy source BAT1 and to a second terminal of the first DC/DC converter DCDC1.

The fourth line section L4 of the second supply line is designed for connecting or is connected to a second terminal of the second energy source BAT2, to a second terminal of the second electrical machine M2, to a second terminal of the second DC/DC converter DCDC2, to a second terminal of the charging unit CHAR, to a second terminal of the first electrical machine M1 and to a second terminal of the at least one further high-voltage load HVL.

The distribution device 100 shown in FIG. 1 is therefore designed for a series vehicle on-board electrical system topology, in which in fault-free operation of the vehicle, the first energy source BAT1 and the second energy source BAT2 are connected in series. The high-voltage system and each of the electrical machines M1, M2 is therefore operated with 800 V in the fault-free case.

In fault-free operation therefore, the third switchgear unit 103 and the first switchgear unit 101 are closed and the second switchgear unit 102 and the fifth switchgear unit 105 are open.

The first energy source BAT1 and the second energy source BAT2 preferably have a fuse, particularly a pyrofuse, in each case. Furthermore, the distribution device 100 can have a further fuse 104, particularly a pyrofuse, in order to enable a disconnection of the at least one high-voltage load HVL from the fifth line section L5. This is advantageous in order to prevent a reaction on the first high-voltage electrical system NET1 and second high-voltage electrical system NET2 of a short circuit in the at least one high-voltage load HVL.

The switchgear units 101, 102, 103, 105 of the distribution device 100 preferably have a controllable disconnector.

The control unit is preferably designed to control a switching position of all switchgear units 101, 102, 103, 105 of the distribution device. The disconnectors for example have gate drivers in each case and the control unit is designed to activate the gate drivers, for example by means of digital signals.

At least the third switchgear unit 103 for example has an internal monitoring unit for an internal current and voltage measurement, by means of which an overcurrent and also over- and undervoltage events can be detected. The third switchgear unit 103 is designed to decide automatically whether the third switchgear unit 103 must be opened or not. If the vehicle is put into a sleep or park mode, the third switchgear unit 103 can for example be opened in a controlled manner by means of the control unit, as the loads on the output side of the switch no longer have to be supplied. That is to say although the third switchgear unit 103 can open automatically, it preferably only does this in an emergency.

As a result of the third switchgear unit 103 being permitted to open automatically, it is possible in the event of a fault to save valuable time and prevent e.g. short circuit currents from becoming very high.

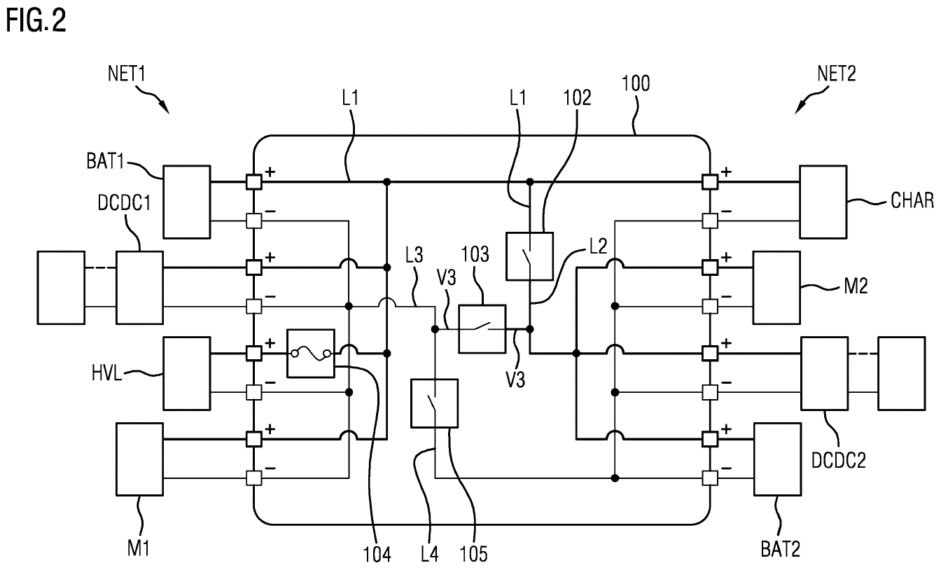

FIG. 2 shows an exemplary block diagram for an exemplary embodiment of a second high-voltage system for an electrically driven vehicle.

The high-voltage system comprises a first high-voltage electrical system NET1, a second high-voltage electrical system NET2 and a distribution system.

The first high-voltage electrical system NET1 comprises a first energy source BAT1, a first electrical machine M1, a first DC/DC converter DCDC1 and one or more high-voltage loads HVL.

The second high-voltage electrical system NET2 comprises a second energy source BAT2, a second electrical machine M2, a second DC/DC converter DCDC2 and a charging unit CHARG.

The distribution system comprises a distribution device 100 and a control unit (not shown in FIG. 2). Furthermore, a second computing unit (not shown in FIG. 2) is assigned to the distribution system, which second computing unit is connected to the control unit.

In contrast to the distribution device 100 shown in FIG. 1, the distribution device 100 according to FIG. 2 has no first switchgear unit 101 in the first supply line. The first supply line therefore comprises only the first line section L1 and the second line section L2.

The first line section L1 of the first supply line is designed for connecting to the first terminal of the first energy source BAT1, to the first terminal of the first DC/DC converter DCDC1 and to the first terminal of the at least one high-voltage load HVL. Furthermore, the first line section L1 is designed for connecting to the first terminal of the charging unit CHAR.

The second line section L2 of the first supply line is designed for connecting to the first terminal of the second energy source BAT2, to the first terminal of the second DC/DC converter DCDC2 and to the first terminal of the second electrical machine M2.

The distribution device 100 shown in FIG. 2 is therefore designed for a parallel vehicle on-board electrical system topology, in which in fault-free operation of the vehicle, the first energy source BAT1 and the second energy source BAT2 are connected in parallel. The high-voltage system is therefore operated with 400 V in the fault-free case. The first energy source BAT1 and the second energy source BAT2 can be connected for charging in series, so that fast charging using 800 V is possible.

In fault-free operation therefore, the third switchgear unit 103 is open and the second switchgear unit 102 and the fifth switchgear unit 105 are closed.

The switchgear units 101, 102, 103, 105 of the distribution device 100 preferably have a controllable disconnector.

The control unit is preferably designed to control a switching position of all switchgear units 101, 102, 103, 105 of the distribution device. The disconnectors for example have gate drivers in each case and the control unit is designed to activate the gate drivers, for example by means of digital signals.

At least the second switchgear unit 102 for example has an internal monitoring unit for an internal current and voltage measurement, by means of which an overcurrent and also over- and undervoltage events can be detected. The second switchgear unit 102 is designed to decide automatically whether the second switchgear unit 102 must be opened or not. If the vehicle is put into a sleep or park mode, the second switchgear unit 102 can for example be opened in a controlled manner by means of the control unit, as the loads on the output side of the switch no longer have to be supplied. That is to say although the second switchgear unit 102 can open automatically, it preferably only does this in an emergency.

As a result of the second switchgear unit 102 being permitted to open automatically, it is possible in the event of a fault to save valuable time and prevent e.g. short circuit currents from becoming very high.

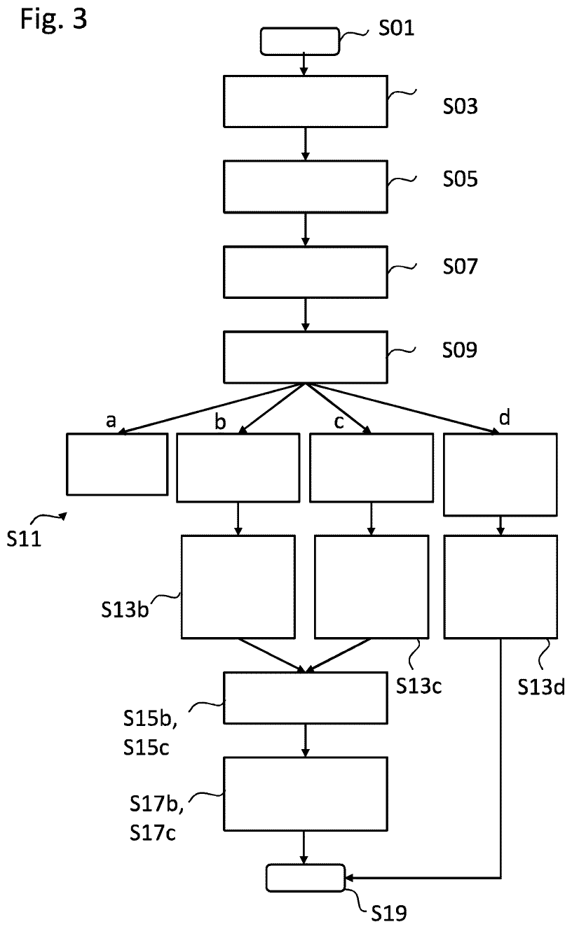

FIG. 3 shows an exemplary flowchart for a program for operating the high-voltage electrical system according to FIG. 1. The program is for example stored in a program memory and is executed by a microcontroller or microprocessor of the control unit. The program is started and possibly initialized in a step S01.

The distribution device 100 or the high-voltage electrical system having the first high-voltage electrical system NET1 and the second high-voltage electrical system NET2 has a series topology in this case. The high-voltage electrical system is therefore an 800 V high-voltage electrical system. In fault-free operation, the third switchgear unit 103 and the first switchgear unit 101 are closed and the second switchgear unit 102 and the fifth switchgear unit 105 are open.

If a short circuit occurs in one of the components of the 800 V high-voltage electrical system or in the 800 V wiring system of the 800 V high-voltage electrical system, this is detected by the monitoring unit of the third switchgear unit 103. The third switchgear unit 103 is activated in such a way that the disconnector of the third switchgear unit 103 has an open state and thus the third supply line V3 is interrupted. The short circuit can occur in particular in the first electrical machine M1, in the second electrical machine M2 or in the at least one high-voltage load HVL and/or in the high-voltage wiring system. The transition of the third switchgear unit 103 to the open state is controlled by the monitoring unit of the third switchgear unit 103 in order to enable a response time of less than 100 μs.

The monitoring unit of the third switchgear unit 103 sends monitoring data or monitoring signals to the control unit, wherein the monitoring data or the monitoring signals are formed to signal to the control unit that opening of the third switchgear unit 103 has been triggered and a short circuit has been detected.

In a step S03, the control unit therefore receives the monitoring data or monitoring signals sent by the monitoring unit of the third switchgear unit 103. The monitoring data or the monitoring signals can additionally include measurement data which are representative for one or more detected voltages in the first electrical system and/or in the second electrical system.

In a step S05, the control unit generates and sends a first control signal to the first switchgear unit 101 in response to the receipt of the monitoring data or monitoring signals, wherein the first control signal is formed to cause the disconnector of the first switchgear unit 101 to assume an open state and therefore there is no conductive connection between the fifth line section L5 and the sixth line section L6. The opening of the disconnector of the switchgear unit 101 can be controlled by the control unit of the distribution device 100, as a response time of less than 100 ms is satisfactory.

In a step S07, the control unit sends diagnostic data to the central computing unit, wherein the diagnostic data at least specify that the third switchgear unit 103 has been transitioned to an open state or a short circuit has been detected. The diagnostic data can additionally include the measurement data that are transmitted by the monitoring unit.

The central computing unit checks which type of short circuit has occurred or in which component the short circuit has occurred depending on the diagnostic data of the control unit and depending on the vehicle system status data for the central computing unit.

The vehicle system status data for example include component diagnostic data of at least a portion of all of the components that are connected to the high-voltage electrical systems and/or current and/or voltage measurement data.

The central computing unit ascertains, depending on the diagnostic data of the control unit of the distribution device 100 and the vehicle system status data, whether
a) a short circuit exists in the first high-voltage electrical system NET1 and in the second high-voltage electrical system NET2, or
b) a short circuit exists in the first high-voltage electrical system NET1, or
c) a short circuit exists in the second high-voltage electrical system NET2, or
d) no short circuit exists.

Depending on the ascertained fault a), b), c) or d), various sequences of steps are carried out by the control unit. In response to the sending of the diagnostic data to the central computing unit, the control unit receives a control command from the central computing unit in a step S09.

If the central processing unit determines that there is a short circuit in the first high-voltage system and the second high-voltage system, the control command has an instruction that causes the control unit to transfer all switching units of the distribution device to an open state or to keep them open. The control unit executes, if necessary, the control command in a step S11a.

If the central computing unit ascertains that the case b), i.e. a short circuit only in the first high-voltage electrical system, exists, the control command includes an instruction to send a second control signal to the second switchgear unit 102, wherein the second control signal is formed to cause the disconnector of the second switchgear unit 102 to be transitioned to a closed state. The control unit executes the control command in a step S11b.

The central computing unit therefore starts, together with the control unit, a resumption of traction operation in the second high-voltage electrical system NET2 using 400 V.

In a step S13b, the control unit sends further up-to-date measurement data that are received from the monitoring unit of the third switchgear unit 103 to the central computing unit, wherein the measurement data are representative for one or more voltages that have been detected following the opening of the first switchgear unit 101 in the first high-voltage electrical system NET1 and/or the second high-voltage electrical system NET2.

The central computing unit ascertains or investigates whether the short circuit in the first high-voltage electrical system NET1 still exists depending on the up-to-date measurement data and the most recently provided vehicle system status data which were detected following the opening of the first switchgear unit 101. If the central computing unit ascertains that no short circuit exists in the first high-voltage electrical system NET1, it sends a further control command to the control unit.

Thus, if the central computing unit ascertains that no short circuit exists in the first high-voltage electrical system NET1, the control unit receives the further control command from the central computing unit in a step S15b. The further control command causes the control unit to send a fifth control signal to the second switchgear unit 102 in a step S17b, wherein the fifth control signal is formed to cause the disconnector of the second switchgear unit 102 to be transitioned to an open state, and a sixth control signal to the first switchgear unit 101 and third switchgear unit 103, wherein the sixth control signal is formed to cause the respective disconnector of the first switchgear unit 101 and the third switchgear unit 103 to be transitioned to a closed state.

The central computing unit therefore starts a resumption of traction operation using 800 V.

If, however, the central computing unit ascertains that the case c), i.e. a short circuit only in the second high-voltage electrical system, exists, the control command includes an instruction to send a third control signal to the fifth switchgear unit 105, wherein the third control signal is formed to cause the disconnector of the fifth switchgear unit 105 to be transitioned to a closed state. The control unit executes the control command in a step S11c.

The central computing unit therefore starts a resumption of traction operation in the first high-voltage electrical system NET1 using 400 V.

The further steps S13c to S17c, which are executed for the case c), are the same as the steps S13b to S17b in case b) with the difference that the fifth control signal is sent to the fifth switchgear unit 105 and the fifth switchgear unit 105 is opened and not the second switchgear unit 102.

If the central computing unit ascertains that the case d), i.e. no short circuit, exists, the control command includes an instruction to send a fourth control signal to the first switchgear unit 101 and third switchgear unit 103, wherein the fourth control signal is formed to cause the disconnector of the first switchgear unit 101 and the third switchgear unit 103 to be transitioned to a closed state. The control unit executes the control command in a step S11d.

The central computing unit therefore starts in a step S13d a resumption of traction operation in the whole high-voltage electrical system using 800 V.

The program ends in a step S19.

### Additional Function—400 V Charging

The switch topology of the distribution device 100 has the additional advantage that an 800 V high-voltage system with series topology can be charged using a 400 V charging station.

For the 400 V charging, the third switchgear unit 103 is transitioned to an open state. Preferably, the high-voltage loads are switched off or changed over to 400 V beforehand. In a further step, the second switchgear unit 102 and the fifth switchgear unit 105 are transitioned to a closed state. This switch state is maintained until the 400 V charging should be ended. For this, the second switchgear unit 102 and the fifth switchgear unit 105 are initially transitioned back to an open state and, in another further step, the third switchgear unit 103 is transitioned to a closed state. The vehicle is therefore ready again for 800 V driving operation or 800 V charging operation.

The change-over of the circuit-breaker units is performed for example by the control unit, which executes a suitable program.

### Malfunctions of the Circuit-Breaker Units

The switch topology of the distribution device 100 has the additional advantage that when a fault occurs in the switchgear units 101, 102, 103, 105, for example undesired opening, the system can at least continue to be operated in a limited mode.

### First Switchgear Unit 101 Malfunction

If, in the series topology for example, the first switchgear unit 101 undesirably has an open state, then the second electrical machine is de-energized, as the second switchgear unit 102 has an open state in the normal operating mode. Traction operation of the first electrical machine can in this case be continued using 800 V without interruption.

Alternatively, operation can take place using two electrical machines M1, M2 which are supplied with 400 V. This enables a restoration of a fail operational state, i.e. even if an electrical machine M1, M2 fails, the vehicle is still operational, at least to a limited extent. The change-over to operation using two electrical machines M1, M2 at 400 V can for example take place when the vehicle is at a standstill or in a moderate traction phase. For this, the third switchgear unit 103 is transitioned to an open state and subsequently the second switchgear unit 102 and the fifth switchgear unit 105 are transitioned to a closed state.

The traction operation of the first electrical machine M1 and the second electrical machine M2 at 400 V can for example take place within 150 ms after the occurrence of the fault (undesired opening of the first switchgear unit 101).

### Second Switchgear Unit 102 Malfunction

If, in the series topology for example, the second switchgear unit 102 undesirably has a closed state, the first energy source BAT1 is short-circuited, i.e. a short circuit occurs in the first high-voltage electrical system NET1. In this case, the third switchgear unit 103 opens. The opening is controlled by the monitoring unit of the third switchgear unit 103, as this detects a short circuit current in this case. The response time is therefore preferably less than 100 μs. In a next step, the fifth switchgear unit 105 is transitioned to a closed state. The control unit controls the closing of the fifth switchgear unit 105 for example. As no current flow exists, a response time of less than 100 ms, better less than 20 ms is satisfactory in this case. In this fault case, traction operation of the first electrical machine M1 and the second electrical machine M2 therefore takes place using 400 V and the two energy sources BAT1, BAT2 are operated in parallel. The change-over to this operating mode can be complete within 150 ms after the occurrence of the fault.

### Fifth Switchgear Unit 105 Malfunction

If, in the series topology for example, the fifth switchgear unit 105 undesirably has a closed state, the second energy source BAT2 is short-circuited, i.e. a short circuit occurs in the second high-voltage electrical system NET2. In this case, the third switchgear unit 103 opens. The opening is controlled by the monitoring unit of the third switchgear unit 103, as this detects a short circuit current in this case. The response time is therefore preferably <100 μs. In a next step, the second switchgear unit 102 is closed. The control unit controls the closing of the second switchgear unit 102 for example. As no current flow exists, a response time of less than 100 ms, better less than 20 ms is satisfactory in this case. In this fault case, traction operation of the first electrical machine M1 and the second electrical machine M2 therefore takes place using 400 V and the two energy sources BAT1, BAT2 are operated in parallel. The changeover to this operating mode can be complete within 150 ms after the occurrence of the fault.

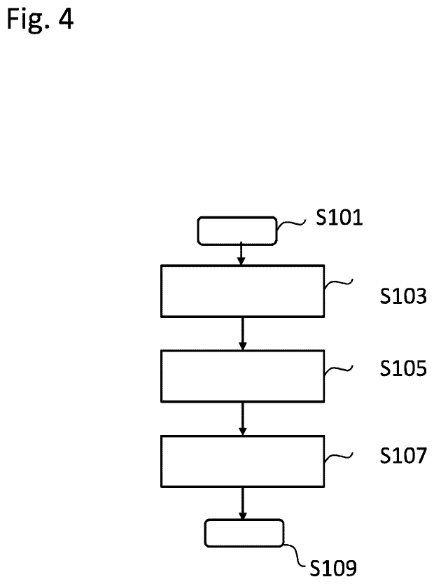

FIG. 4 shows an exemplary flowchart for a further program for operating the high-voltage electrical system according to FIG. 2. The further program is for example stored in a program memory and is executed by a microcontroller or microprocessor of the control unit. The further program is started and possibly initialized in a step S101.

The distribution device or the high-voltage electrical system having the first high-voltage electrical system NET1 and the second high-voltage electrical system NET2 has a parallel topology in this case. The high-voltage electrical system is therefore a 400 V high-voltage electrical system in which the first energy store BAT1 and the second energy store BAT2 are operated in parallel in fault-free operation. In fault-free operation, the third switchgear unit 103 is open and the second switchgear unit 102 and the fifth switchgear unit 105 are closed.

If a short circuit occurs in one of the components of the 400 V high-voltage electrical system or in the 400 V wiring system of the 400 V high-voltage electrical system, this is detected by the monitoring unit of the second switchgear unit 102. The short circuit may occur in the first energy source BAT1, in the second energy source BAT2, in the first electrical machine M1, in the second electrical machine M2, in the first DC/DC converter DCDC1 or the second DC/DC converter DCDC2 or in the at least one high-voltage load HVL and/or in the 400 V high-voltage wiring system. The transition of the second switchgear unit 102 to the open state is controlled by the monitoring unit of the second switchgear unit 102 in order to enable a response time of less than 100 μs. Due to the opening of the second switchgear unit 102, the connection between the first line section L1 of the first supply line and the second line section L2 of the first supply line is interrupted.

The monitoring unit of the second switchgear unit 102 sends monitoring data or monitoring signals to the control unit, wherein the monitoring data or the monitoring signals are formed to signal to the control unit that opening of the second switchgear unit 102 has been triggered and a short circuit has been detected.

In a step S103, the control unit therefore receives the monitoring data or monitoring signals sent by the monitoring unit of the second switchgear unit 102. These can additionally include measurement data which are representative for one or more detected voltages in the first high-voltage electrical system NET1 and/or in the second high-voltage electrical system NET2.

In response to the receipt of the monitoring data or the monitoring signals, the control unit generates and sends a control signal to the fifth switchgear unit 105 in a step S105, wherein the control signal is formed to cause the disconnector of the fifth switchgear unit 105 to assume an open state.

In a step S107, the control unit sends diagnostic data to the central computing unit, wherein the diagnostic data at least specify that the second switchgear unit 102 has been transitioned to an open state or a short circuit has been detected. The diagnostic data can additionally include the measurement data that are transmitted by the monitoring unit.

### The Program Ends in a Step S109.

The central computing unit checks which type of short circuit has occurred or in which component the short circuit has occurred depending on the diagnostic data of the control unit and depending on the vehicle system status data for the central computing unit.

The central computing unit ascertains, depending on the diagnostic data of the control unit of the distribution device and the vehicle system status data, whether
a) a short circuit exists in the first high-voltage electrical system, or
b) a short circuit exists in the second high-voltage electrical system.

If a short circuit exists in the first high-voltage electrical system, the central computing unit starts traction operation in the second high-voltage electrical system NET2 using 400 V. If a short circuit exists in the second high-voltage electrical system, the central computing unit starts traction operation in the first high-voltage electrical system NET1 using 400 V.

### Malfunctions of the Third Switchgear Unit 103

If, in the parallel topology for example, the third switchgear unit 103 undesirably has a closed state, the second switchgear unit 102 opens. Thus, the first high-voltage electrical system NET1 is disconnected from the second high-voltage electrical system NET2. The opening is controlled by the monitoring unit of the second switchgear unit 102, as this detects a short circuit current in this case. The response time is therefore preferably less than 100 μs. In this fault case, traction operation of the first electrical machine M1 and the first high-voltage electrical system NET1 is continued using 400 V. In addition, the fifth switchgear unit 105 is closed. The control unit controls the closing of the fifth switchgear unit 105 for example. As no current flow exists, because for example a pyrofuse of the second energy source BAT2 has been tripped, a response time of less than 100 ms is satisfactory in this case.

### Third Switchgear Unit 103 Malfunction

If, in the parallel topology for example, the third switchgear unit 103 undesirably has a closed state, the second switchgear unit 102 and the fifth switchgear unit 105 open. The opening of the second switchgear unit 102 is controlled by the monitoring unit of the second switchgear unit 102 and the opening of the fifth switchgear unit 105 is controlled by the monitoring unit of the fifth switchgear unit 105, as the short circuit current increases fast in this case. In this fault case, traction operation is resumed with the first high-voltage electrical system NET1 and the second high-voltage electrical system NET2 using 400 V. This is for example possible within 50 ms after detection of the fault.

### Second/Fifth Switchgear Unit 102/105 Malfunction

If, in the parallel topology for example, the second switchgear unit 102 or the fifth switchgear unit 105 undesirably has an open state, no short circuit exists and a continuation of traction operation is possible with the first high-voltage electrical system NET1 and the second high-voltage electrical system NET2 using 400 V in each case. Optionally, in order to minimize a risk of an “undesirable” closing of the third switchgear unit 103, the fifth switchgear unit 105 or the second switchgear unit 102 can be opened in a next step. The control unit controls this opening of the fifth switchgear unit 105 or the second switchgear unit 102 for example. As no current flow exists, a response time of less than 100 ms is satisfactory in this case.

Advantageously, the distribution device and the distribution system are based on an intelligent interconnection and/or change-over of the energy sources BAT1, BAT2 including the electrical machines M1, M2 to operate different loads (incl. the electrical machines M1, M2 that are operated as motors) to fulfill the functional requirements, for example for autonomous driving, using a minimum number of high-voltage components. By means of the intelligent, fast and safe change-over of available sources (inputs) and sinks (outputs), main functions, traction redundancy in the event of a fault, redundant and independent low-voltage supply and legacy charging using only one distribution component can be realized using the distribution device.

List of reference signs

| | |
|---|---|
| 100 | Distribution device |
| 101 | First switchgear unit |
| 102 | Second switchgear unit |
| 103 | Third switchgear unit |
| 104 | Controllable fuse |
| 105 | Fifth switchgear unit |
| BAT1 | First energy source |
| BAT2 | Second energy source |
| CHAR | Charging unit |
| DCDC1 | First DC/DC converter |
| DCDC2 | Second DC/DC converter |
| HVL | High-voltage load |
| L1 | First line section |
| L2 | Second line section |
| L3 | Third line section |
| L4 | Fourth line section |
| L5 | Fifth line section |
| L6 | Sixth line section |
| M1 | First electrical machine |
| M2 | Second electrical machine |
| S01 . . . S109 | Program steps |
| V3 | Third supply line |

1. A distribution device for a high-voltage system of an electric vehicle, wherein the high-voltage system has a first high-voltage electrical system and a second high-voltage electrical system and the distribution device has:
a first supply line having a first line section, a second line section and a controllable second switchgear unit, wherein the second switchgear unit connects the first line section and second line section in a closed state and decouples the first line section and second line section in an open state,
a second supply line having a third line section, a fourth line section and a controllable fifth switchgear unit, wherein the fifth switchgear unit connects the third line section and fourth line section in a closed state and decouples the third line section and fourth line section in an open state,
a third supply line having a controllable third switchgear unit, wherein the third switchgear unit connects the second line section of the first supply line and third line section of the second supply line, wherein
the first line section of the first supply line is designed for connecting to a first terminal of a first energy source, to a first terminal of a first electrical machine, to a first terminal of a charging unit, to a first terminal of a first DC/DC converter and to a first terminal of at least one further high-voltage load,
the second line section of the first supply line is designed for connecting to a first terminal of a second energy source and to a first terminal of a second DC/DC converter,
the third line section of the second supply line is designed for connecting to a second terminal of the first energy source and to a second terminal of the first DC/DC converter,
the fourth line section of the second supply line is designed for connecting to a second terminal of the second energy source, to a second terminal of the second electrical machine, to a second terminal of a second DC/DC converter and to a second terminal of a charging unit.

2. The distribution device as claimed in claim 1, wherein
the second line section of the first supply line is designed for connecting to a first terminal of the second electrical machine,
the third line section of the second supply line is designed for connecting to a second terminal of the first electrical machine and to a second terminal of the at least one further high-voltage load.

3. The distribution device as claimed in claim 1, wherein
the first supply line has a switchable first switchgear unit which is arranged in the first line section and divides the first line section into a fifth line section and sixth line section, so that the fifth line section of the first supply line is designed for connecting to the first terminal of the first energy source, to the first terminal of the first electrical machine, to a first terminal of the first DC/DC converter and to the first terminal of the at least one further high-voltage load, and the sixth line section of the first supply line is designed for connecting to the first terminal of the charging unit and the first terminal of the second electrical machine, and
the fourth line section of the second supply line is designed for connecting to a second terminal of the at least one high-voltage load and to a second terminal of the first electrical machine.

4. The distribution device as claimed in claim 1, wherein
the third switchgear unit is designed to control opening of the third switchgear unit automatically and/or
the second switchgear unit is designed to control opening of the second switchgear unit automatically.

5. The distribution device as claimed in claim 4, wherein
the third switchgear unit has a controllable disconnector and a monitoring unit, wherein the monitoring unit is arranged in the third switchgear unit and is designed to detect a current which is flowing in the third switchgear unit and/or a voltage which is applied at the third switchgear unit, and to transition the controllable disconnector to an open state if a magnitude of the current or the voltage exceeds a specified first value or falls below a specified second value, or
the second switchgear unit has a controllable disconnector and a monitoring unit, wherein the monitoring unit is arranged in the second switchgear unit and is designed to detect a current which is flowing in the second switchgear unit and/or a voltage which is applied at the second switchgear unit, and to transition the controllable disconnector to an open state if a magnitude of the current or the voltage exceeds a specified first value or falls below a specified second value.

6. The distribution device as claimed in claim 5, wherein the respective controllable disconnector can additionally be activated by the control unit.

7. A method for operating a high-voltage system of an electric vehicle, wherein the high-voltage system has a first high-voltage electrical system and a second high-voltage electrical system and also a distribution device as claimed in and the method comprises the follow
receiving monitoring data or monitoring signals from the monitoring unit of the third switchgear unit by the control unit, wherein the monitoring data or the monitoring signals are formed to signal to the control unit that opening of the third switchgear unit has been triggered and a short circuit has been detected,
in response to the receipt of the monitoring data or the monitoring signals, generating and sending a first control signal to the first switchgear unit by the control unit, wherein the first control signal is formed to cause the disconnector of the first switchgear unit to assume an open state,
sending diagnostic data to central computing unit by the control unit to ascertain which type of short circuit fault exists, wherein the diagnostic data at least specify that the third switchgear unit has been transitioned to an open state or a short circuit has been detected,
in response to the sending of the diagnostic data to the central computing unit, receiving a control command from the central computing unit by the control unit, wherein
a) if the central computing unit ascertains that a short circuit exists in the first high-voltage electrical system and the second high-voltage electrical system, the control command includes no instruction that causes the control unit to reconnect one of the high-voltage electrical systems,
b) if the central computing unit ascertains that a short circuit only exists in the first high-voltage electrical system, the control command includes an instruction to send a second control signal to the second switchgear unit, wherein the second control signal is formed to cause the disconnector of the second switchgear unit to be transitioned to a closed state,
c) if the central computing unit ascertains that a short circuit only exists in the second high-voltage electrical system, the control command includes an instruction to send a third control signal to the fifth switchgear unit, wherein the third control signal is formed to cause the disconnector of the fifth switchgear unit to be transitioned to a closed state,
d) if the central computing unit ascertains that no short circuit exists, the control command includes an instruction to send a fourth control signal to the first switchgear unit and third switchgear unit, wherein the fourth control signal is formed to cause the respective disconnector of the first switchgear unit and the third switchgear unit to be transitioned to a closed state,
executing the control command by means of the control unit.

8. The method as claimed in claim 7, wherein, in case b) and c), the method further comprising:
receiving up-to-date measurement data from the monitoring unit of the third switchgear unit and forwarding the measurement data to the central computing unit by the control unit, wherein the measurement data are representative for one or more voltages that have been detected following the opening of the first switchgear unit in the first high-voltage electrical system and/or the second high-voltage electrical system,
in response to the forwarding of the measurement data, receiving a further control command from the central computing unit by means of the control unit, wherein the further control command includes an instruction to send a fifth control signal to the second switchgear unit in case b) and to the fifth switchgear unit in case c), wherein the fifth control signal is formed to cause the disconnector of the second switchgear unit or the fifth switchgear unit to be transitioned to an open state, and to send a sixth control signal to the first switchgear unit and third switchgear unit, wherein the sixth control signal is formed to cause the respective disconnector of the first switchgear unit and the third switchgear unit to be transitioned to a closed state.

9. A control unit for operating a high-voltage system of an electric vehicle, wherein the high-voltage system has a first high-voltage electrical system and a second high-voltage electrical system and also a distribution device as claimed in claim 3, and the control unit is designed to execute a method comprising:
receiving monitoring data or monitoring signals from the monitoring unit of the third switchgear unit by the control unit, wherein the monitoring data or the monitoring signals are formed to signal to the control unit that opening of the third switchgear unit has been triggered and a short circuit has been detected,
in response to the receipt of the monitoring data or the monitoring signals, generating and sending a first control signal to the first switchgear unit by the control unit, wherein the first control signal is formed to cause the disconnector of the first switchgear unit to assume an open state,
sending diagnostic data to central computing unit by the control unit to ascertain which type of short circuit fault exists, wherein the diagnostic data at least specify that the third switchgear unit has been transitioned to an open state or a short circuit has been detected,
in response to the sending of the diagnostic data to the central computing unit receiving a control command from the central computing unit by the control unit, wherein
a) if the central computing unit ascertains that a short circuit exists in the first high-voltage electrical system and the second high-voltage electrical system, the control command includes no instruction that causes the control unit to reconnect one of the high-voltage electrical systems,
b) if the central computing unit ascertains that a short circuit only exists in the first high-voltage electrical system, the control command includes an instruction to send a second control signal to the second switchgear unit, wherein the second control signal is formed to cause the disconnector of the second switchgear unit to be transitioned to a closed state,
c) if the central computing unit ascertains that a short circuit only exists in the second high-voltage electrical system, the control command includes an instruction to send a third control signal to the fifth switchgear unit, wherein the third control signal is formed to cause the disconnector of the fifth switchgear unit to be transitioned to a closed state,
d) if the central computing unit ascertains that no short circuit exists, the control command includes an instruction to send a fourth control signal to the first switchgear unit and third switchgear unit, wherein the fourth control signal is formed to cause the respective disconnector of the first switchgear unit and the third switchgear unit to be transitioned to a closed state, and executing the control command by the control unit.

10. A distribution system having a distribution device as claimed in claim 3 and a control unit for operating a high-voltage system of an electric vehicle, wherein the high-voltage system has a first high-voltage electrical system and a second high-voltage electrical system, the control unit is designed to execute a method comprising:
receiving monitoring data or monitoring signals from the monitoring unit of the third switchgear unit by the control unit, wherein the monitoring data or the monitoring signals are formed to signal to the control unit that opening of the third switchgear unit has been triggered and a short circuit has been detected,
in response to the receipt of the monitoring data or the monitoring signals, generating and sending a first control signal to the first switchgear unit by the control unit, wherein the first control signal is formed to cause the disconnector of the first switchgear unit to assume an open state,
sending diagnostic data to central computing unit by the control unit to ascertain which type of short circuit fault exists, wherein the diagnostic data at least specify that the third switchgear unit has been transitioned to an open state or a short circuit has been detected,
in response to the sending of the diagnostic data to the central computing unit receiving a control command from the central computing unit by the control unit, wherein
a) if the central computing unit ascertains that a short circuit exists in the first high-voltage electrical system and the second high-voltage electrical system, the control command includes no instruction that causes the control unit to reconnect one of the high-voltage electrical systems,
b) if the central computing unit ascertains that a short circuit only exists in the first high-voltage electrical system, the control command includes an instruction to send a second control signal to the second switchgear unit, wherein the second control signal is formed to cause the disconnector of the second switchgear unit to be transitioned to a closed state,
c) if the central computing unit ascertains that a short circuit only exists in the second high-voltage electrical system, the control command includes an instruction to send a third control signal to the fifth switchgear unit, wherein the third control signal is formed to cause the disconnector of the fifth switchgear unit to be transitioned to a closed state,
d) if the central computing unit ascertains that no short circuit exists, the control command includes an instruction to send a fourth control signal to the first switchgear unit and third switchgear unit, wherein the fourth control signal is formed to cause the respective disconnector of the first switchgear unit and the third switchgear unit to be transitioned to a closed state, and executing the control command by the control unit.

11. A high-voltage system for an electric vehicle, wherein the high-voltage system has a first high-voltage electrical system and a second high-voltage electrical system, and a distribution system as claimed in claim 10.

12. A computer program comprising commands which, when the computer program is executed by a computing unit of a high-voltage system of an electric vehicle, cause the computing unit to carry out the steps of the method as claimed in claim 7.

13. A non-transitory computer-readable medium comprising commands which, when executed by a computing unit of a high-voltage system of an electric vehicle, cause the computing unit to execute the method as claimed in claim 7.

14. A computer program comprising commands which, when the computer program is executed by a computing unit of a high-voltage system of an electric vehicle, cause the computing unit to carry out the steps of the method as claimed in claim 8.

15. A non-transitory computer-readable medium comprising commands which, when executed by a computing unit of a high-voltage system of an electric vehicle, cause the computing unit to execute the method as claimed in claim 8.
